(19) United States
(12) Patent Application Publication
(10) Pub. No.: US 2008/0311260 A1
(43) Pub. Date: Dec. 18, 2008

(54) FREEZE-DRYING ARTICLES

(75) Inventors: Norman Eugene Jager, Albany, OR (US); James Lester Hook, Jefferson, OR (US)

Correspondence Address: KLARQUIST SPARKMAN, LLP, 121 SW SALMON STREET, SUITE 1600, PORTLAND, OR, 97204, US

(73) Assignee: Oregon Freeze Dry, Inc.

(21) Appl. No.: 12/138,130

(22) Filed: Jun. 12, 2008

Related U.S. Application Data
(60) Provisional application No. 60/934,866, filed on Jun. 14, 2007.

(51) Int. Cl. A23C 1/06; A47J 43/00; B23K 26/38

(52) U.S. Cl. 426/385; 99/537; 219/121.7

(57) ABSTRACT

An article can be prepared for freeze-drying by creating one or more incisions in the article. In embodiments of the disclosed technologies, the one or more incisions can be made using a laser, a device which dispenses a quantity of liquid nitrogen, and/or an ultrasonic cutting device. The incisions can improve the quality of the article when, for example, it is freeze-dried or freeze-dried and rehydrated. At least some embodiments of the disclosed technologies can be used to prepare groups of one or more articles having non-uniform sizes.

### CROSS REFERENCE TO RELATED APPLICATION

This application claims the benefit of U.S. Provisional Patent Application No. 60/934,866, titled “Laser-Assisted Freeze Drying” and filed Jun. 14, 2007, which is incorporated herein by reference.

### FIELD

The disclosed technologies relate to freeze-drying articles, including food articles.

### BACKGROUND

Freeze-drying is often used to preserve articles such as food or pharmaceutical products. The quality of some freeze-dried items can be improved by mechanically cutting or piercing the items (e.g., frozen items) before they are freeze-dried. Particularly for fruits and vegetables that are freeze-dried whole, a piercing or cutting of the item's skin can allow water vapors to more easily escape the item and help prevent collapse. As used herein, “collapse” is a condition in which areas of interior ice in freeze-dried article melt because the rate of water vapor escaping through the article's skin or through an open surface is higher than the available porosity of the skin or open surface. This water vapor pressure builds up just below the interior surface layer and causes an increase in local temperature beyond the melting point. The resulting temperature and pressure increase locally melts the ice, and the solids collapse into the liquid space prior to further freeze-drying.

However, mechanically cutting or piercing articles can have drawbacks, particularly for articles which do not necessarily have uniform size (e.g., peas or blueberries of non-uniform size). Generally, when articles of non-uniform size are mechanically cut or pierced, some of the largest articles can be crushed or cut in half, while some of the smallest articles can be cut or pierced inadequately, or not at all. Accordingly, mechanical cutting or piercing can cause undesired damage to some of the articles, which can result in a loss of product and/or a less appealing appearance. Furthermore, it can be difficult and expensive to purchase commercially size-graded articles, for example, peas and blueberries.

As another example, whole kernel corn can be freeze-dried by making relatively shallow cuts of kernels from a cob. The shallow cuts are made by increasing the distance of the cutting blade from the cob, such that the cut kernels are thin enough and possess sufficient surface area to allow moisture to escape from the kernels during freeze-drying. However, the shallow cuts can reduce the yield of corn cut from the cob.

### SUMMARY

An article can be prepared for freeze-drying by creating one or more incisions in the article. In embodiments of the disclosed technologies, the one or more incisions can be made using a laser, a device which dispenses a quantity of liquid nitrogen, and/or an ultrasonic cutting device. The incisions can improve the quality of the article when, for example, it is freeze-dried or freeze-dried and rehydrated. At least some embodiments of the disclosed technologies can be used to prepare groups of one or more articles having non-uniform sizes.

In some embodiments, a method of processing one or more articles comprises: creating at least one incision in the one or more articles using at least a laser, a quantity of liquid nitrogen, an ultrasonic cutting device, or a combination thereof; and freeze-drying the one or more articles. The method can further comprise rehydrating and/or partially rehydrating the one or more freeze-dried articles. The articles can comprise a skin or membrane pierced by at least one of the incisions. The articles can comprise articles of substantially different sizes. In some cases the incisions are created while the one or more articles are suspended in a fluid. A laser can be used to create at least one incision. The article can comprise a food article, and the method can further comprise receiving one or more food articles. A quantity of liquid nitrogen can be used to create the at least one incision. The quantity of liquid nitrogen can be applied to the one or more articles at an angle less than 90 degrees relative to the one or more articles. An ultrasonic cutting device can be used to create the at least one incision. A freeze-dried article processed according to one or more embodiments of the above method can be at least partially rehydrated.

In further embodiments, a freeze-dried article comprises an exterior surface, the exterior surface comprising one or more incisions, wherein the incisions were created at least in part by one or more of a laser beam, a quantity of liquid nitrogen, and an ultrasonic cutting device. In some cases, at least a portion of the article is discolored as a result of the one or more incisions. In some cases the incisions were created by a laser beam, in some cases they were created by a quantity of liquid nitrogen, and in some cases they were created by an ultrasonic cutting device. The article can be a food article.

In additional embodiments, a system comprises: a device configured to pierce one or more holes in a product, wherein the device comprises one or more of a laser, a quantity of liquid nitrogen, and an ultrasonic cutting device; and a freeze-drying unit configured to receive and freeze dry the product having one or more holes. In some cases, the piercing device comprises a laser. The system can further comprise a marking head configured to direct a laser beam emitted by the laser. The product can comprise a food product. The system can further comprise a receiving area for the product. The piercing device can comprise a quantity of liquid nitrogen. In further embodiments, the piercing device can comprise an ultrasonic cutting device. The device configured to pierce one or more holes in the product can be configured to pierce at least one of the holes completely through the product.

### BRIEF DESCRIPTION OF THE DRAWINGS

FIG. 1 shows a block diagram of an exemplary embodiment of a method of freeze-drying articles.

FIG. 2 shows a diagram of an exemplary embodiment of a system for performing techniques described herein.

FIG. 3 shows a diagram of an exemplary embodiment of a system for performing techniques described herein.

FIG. 4 shows a photograph of exemplary sausages treated using a technique described herein.

FIG. 5 shows a photograph of a cross-section of an exemplary treated sausage.

FIGS. 6-11 show photographs of exemplary treated and/or untreated sausages.

### DETAILED DESCRIPTION

Disclosed below are embodiments of freeze-drying technologies, products and/or related systems and methods. The embodiments should not be construed as limiting in any way. Instead, the present disclosure is directed toward all novel and nonobvious features and aspects of the various disclosed methods, apparatus, products and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” The phrase “and/or” can mean “and,” “or” and “one or more of” the elements described in the sentence. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

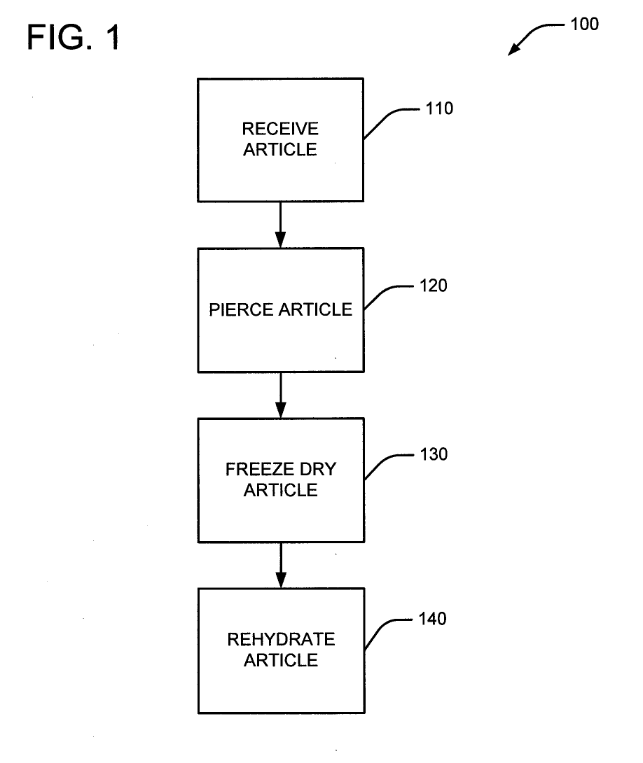

FIG. 1 shows a block diagram of an exemplary embodiment of a method 100 of freeze-drying articles. An article (e.g., a food article, a non-food article) is received (method act 110) and pierced one or more times (method act 120) using, for example, one or more of a laser, a quantity of liquid nitrogen, or an ultrasonic cutting device (e.g., an ultrasonic knife). (In the context of this application and the claims, a “piercing” can include, for example, a “slit” and/or an “incision.”) In one embodiment, a laser, a quantity of liquid nitrogen, or an ultrasonic cutting device is the only piercing device used. Further embodiments contemplate using a combination of a laser and liquid nitrogen, a combination of a laser and an ultrasonic cutting device, or a combination of liquid nitrogen and an ultrasonic cutting device.

The number, size, depth and distribution of piercings can vary from embodiment to embodiment. For example, in some embodiments the piercings penetrate one or more skins or membranes of the article. In further embodiments the piercings increase the exposed surface area of the article. In additional embodiments, one or more piercings penetrate the article entirely. In at least some embodiments, making one or more piercings with a laser can result in the piercings being backfilled with melted portions of the article. With at least some other cutting devices (e.g., a quantity of liquid nitrogen or an ultrasonic cutting device), such backfilling may not occur. The article can be freeze-dried using, for example, one or more of a number of available freeze-drying technologies (method act 130). In some embodiments the article can be rehydrated (method act 140). Generally, the piercings can aid the escape of water vapor from the article during the freeze-drying process. In some embodiments, the piercings can also aid in rehydration of the article by, for example, allowing water to more easily reach portions of the article.

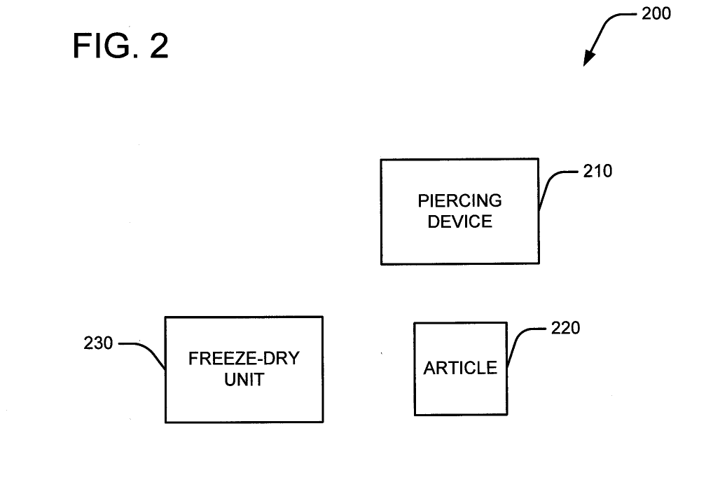

FIG. 2 shows a block diagram of an exemplary embodiment of a system 200 for performing at least some of the techniques described herein. The system 200 comprises a piercing device 210, which can be configured to make one or more piercings in one or more articles 220. The piercing device comprises a laser, a device configured to dispense a quantity of liquid nitrogen, and/or an ultrasonic cutting device. In some embodiments, the operation of the piercing device is controlled at least in part by one or more computers (not shown). In further embodiments the articles 220 can be arranged and supported on a tray or other surface (not shown). The articles 220 can be stationary relative to the piercing device 210, while in some embodiments the articles can be moving relative to the piercing device 210 (e.g., moving on a conveyor belt or other device). In further embodiments, the articles 220 can be pierced by the piercing device 210 while falling or otherwise suspended in a fluid, or covered with a blanket of gas, such as nitrogen and/or one or more other gases. The articles 220 can be freeze-dried by a freeze-drying unit 230.

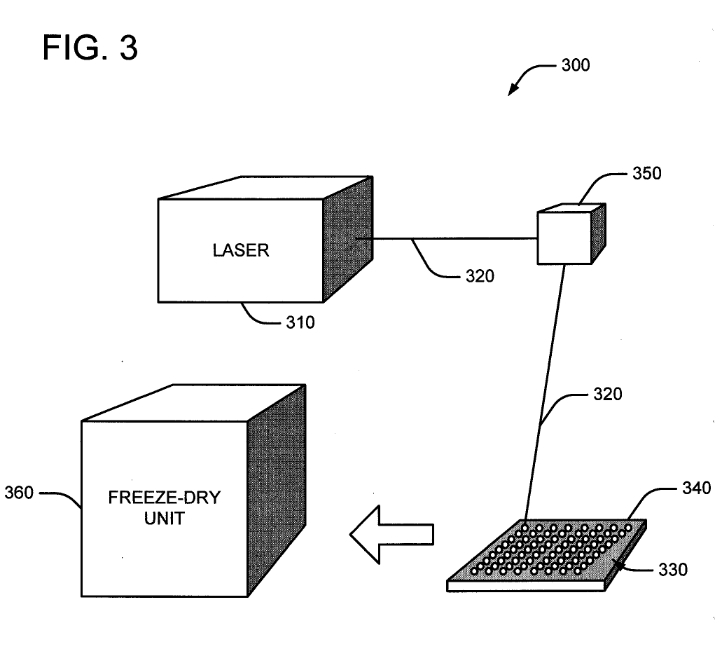

FIG. 3 shows a diagram of one embodiment of an exemplary system 300 for performing techniques described herein. The system 300 can comprise a laser 310 which emits a laser beam 320. Lasers of various strengths and types can be used, and non-limiting examples of some possible lasers are described below with respect to some experimental results. The laser beam 320 is aimed at one or more articles 330 in which piercings are to be made. In some embodiments, the laser beam 320 can be aimed with the assistance of a laser marking head 350, which in some embodiments is controlled at least in part by one or more computers (not shown). In additional embodiments the articles 330 can be arranged and supported on a tray 340 or other surface. The articles 330 can be stationary relative to the laser 310, while in some embodiments the articles can be moving relative to the laser 310 (e.g., moving on a conveyor belt or other device). In further embodiments, the articles 330 can be pierced by the laser beam 320 while falling or otherwise suspended in a fluid, or covered with a blanket of gas, such as nitrogen and/or one or more other gases. The articles 330 can be freeze-dried by a freeze-drying unit 360.

The technologies described herein can be used in freeze-drying a number of articles, for example: fruits (e.g., blueberries, grapes, strawberries, cherries); vegetables (e.g., green peas, soybeans, kidney beans, lima beans); meats (e.g., raw or cooked beef, raw or cooked chicken); entrees; sauces; fruit purees; vegetable purees; food items (e.g., meatballs, ice cream, crab cakes); as well as one or more non-food articles.

Several experimental results illustrate at least some of the technologies described herein. In one experiment, A-grade cultivated blueberries were frozen (at about 0° F. to +10° F.) and placed on a 6″×8″ steel plate, the plate being covered with aluminum foil. The blueberries were placed one layer deep with little space between them.

On the steel plate, the blueberries were placed under a flying marking head with a 158 mm×114 mm field of vision. The dimensions of this particular field of vision left some blueberries on the outside the perimeter of the plate untreated. An 80W t80 laser from Synrad, Inc., was operated at 1000 Hz pulse-width modulation (PWM) with a polyline mark velocity of 100 inches per second and 1000 pulses per second (i.e., 0.1 inches per pulse). However, generally speaking, the laser pulse settings can be independent of the size or shape of the article to be treated. On this set of blueberries an array of 30 lines was run, with the lines spaced 0.15 inches apart. A duplicate set of blueberries were treated using this same parameters.

On each set of frozen blueberries, some untreated blueberries from the outside perimeter of the plate were scarified manually using a circular knife from an Urschel SC scarifier from Urschel Laboratories, Inc. Accordingly, each tray contained untreated control, laser-pierced and manually scarified blueberries.

The blueberries were frozen to −10° F. and freeze-dried using a standard research and development (R & D) cycle of less than 0.5 m/torr with a platen temperature of 100° F., using a cycle of 48 hours.

After freeze-drying the blueberry samples, they were rehydrated using an excess amount of cold water (58° F.-62° F.) for 5 minutes. The rehydrated blueberries were evaluated for a soft natural texture that can be desirable for a freeze-dried, rehydrated blueberry. Examination revealed that the control samples displayed a firm or hard texture and dry centers. The manually-scarified samples had a generally acceptable soft texture, with an occasional sample having a slightly firm texture. The laser-pierced samples had an acceptable soft texture.

In another experiment, a first set of A-grade green peas were frozen at about 0° F. to +10° F. and placed on a 6″×8″ steel plate, the plate being covered with aluminum foil. The peas were placed close together and one layer deep.

On the steel plate, the peas were placed under a flying marking head with a 158 mm×114 mm field of vision. The dimensions of this particular field of vision left some peas on the outside the perimeter of the plate untreated. An 80W t80 laser from Synrad, Inc., was operated at 1000 Hz pulse-width modulation (PWM) with a polyline mark velocity of 100 inches per second and 1000 pulses per second (i.e., 0.1 inches per pulse). On this set of peas an array of 30 lines was run on the peas, with the lines spaced 0.15 inches apart.

A second set of peas (similarly frozen and arranged on a foil-covered steel plate) was treated using a 200W t201 laser from Synrad, Inc. For this set, the laser pulse spacing was set to 0.1 inches per pulse, and an array of 40 lines was run on the peas, with the lines spaced about 0.12 inches apart.

On each set of frozen peas, some untreated peas from the outside perimeter of the plate were scarified manually using a circular knife from an Urschel SC scarifier. Accordingly, each tray contained untreated control, laser-pierced and manually scarified peas.

The peas were frozen to −10° F. and freeze-dried using a standard R&D cycle of less than 0.5 m/torr with a platen temperature of 100° F., using a cycle of 48 hours.

After freeze-drying the pea samples, they were rehydrated using an excess amount of hot water (200° F.) for 5 minutes. The rehydrated peas were evaluated for a soft natural texture that can be desirable for a freeze-dried rehydrated pea. Examination revealed that the control samples displayed a firm texture. The manually-scarified samples had a generally acceptable soft texture, with an occasional sample having a firm texture. The laser-pierced samples had an acceptable soft texture.

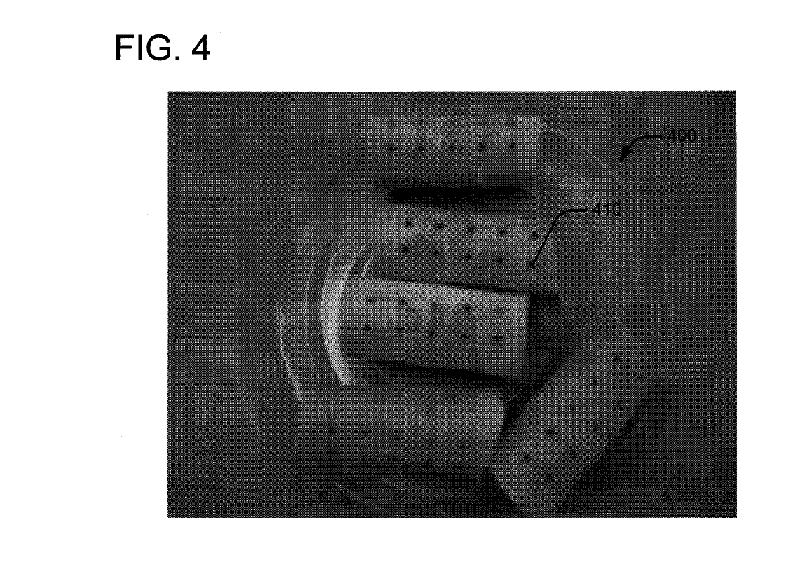

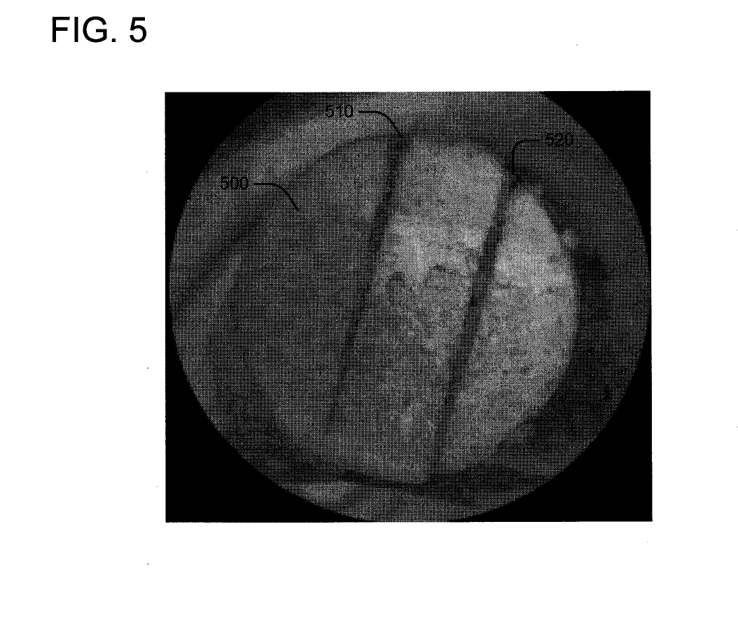

In a further experiment, sausages were treated with a laser using a setup similar to those described above. FIG. 4 shows a photograph of some treated sausages 400, which in this case are sausages intended for animal consumption. However, in further embodiments the disclosed technologies can also be used with sausages or other items meant for human consumption, as well as with non-food items. As seen in FIG. 4, each sausage was pierced with a laser to create ten holes (such as the hole 410), though other numbers of holes can be used. FIG. 5 shows a photograph of a cross-section of a treated sausage 500, cut along two holes created by the laser. The holes appear as dark lines 510, 520 in the photograph. As seen in FIG. 5, in this particular embodiment the holes were cut through the entire sausage by the laser. However, in further embodiments the holes can be cut through a limited portion of an article, including through a selected skin or membrane. In some embodiments, holes of varying depths can be cut in an article. FIGS. 4 and 5 show a sausage that has not been freeze-dried.

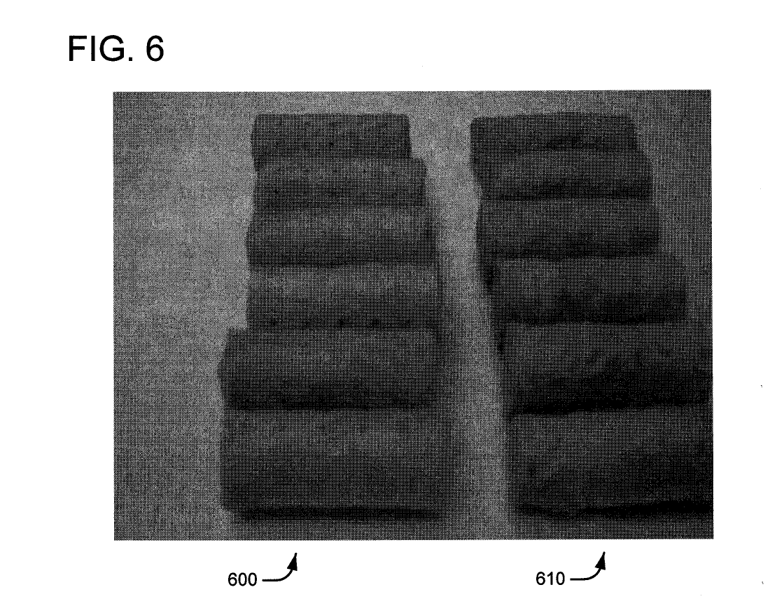

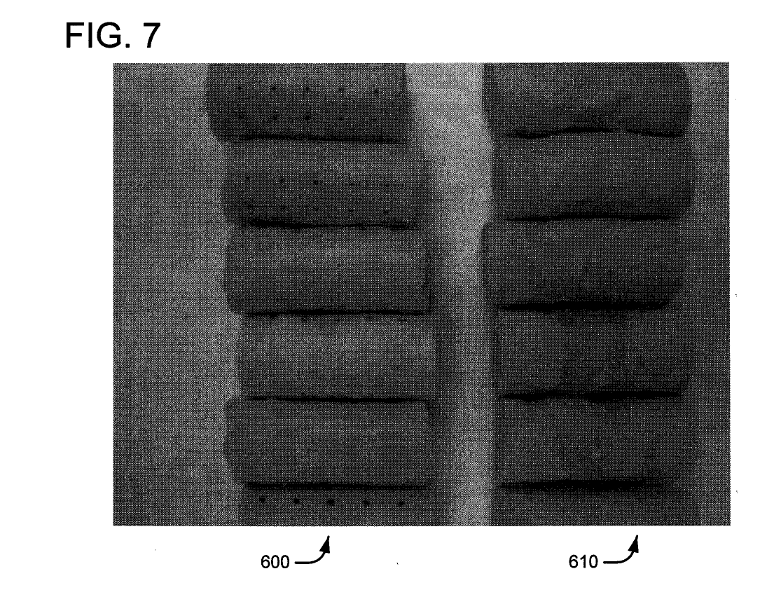

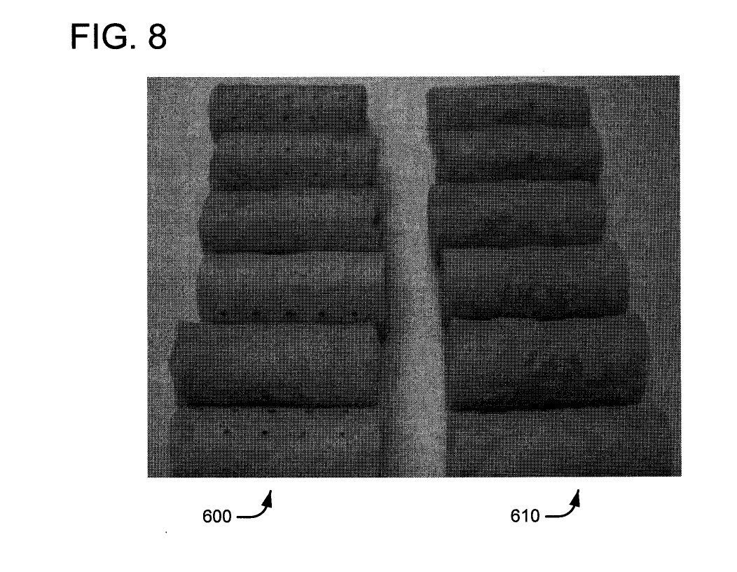

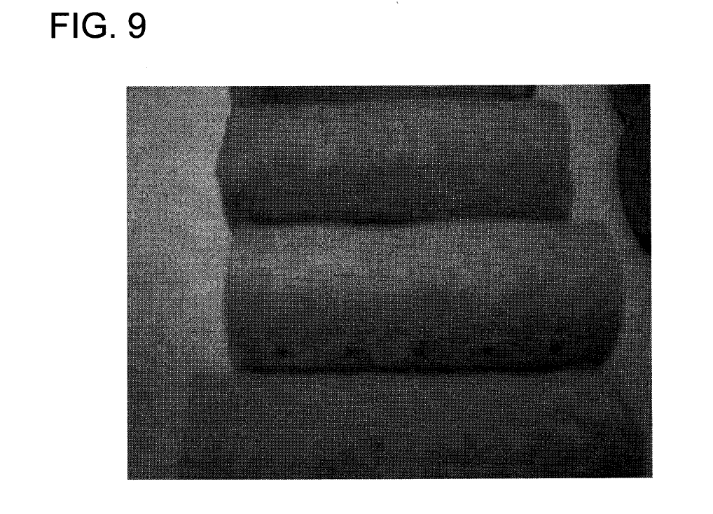

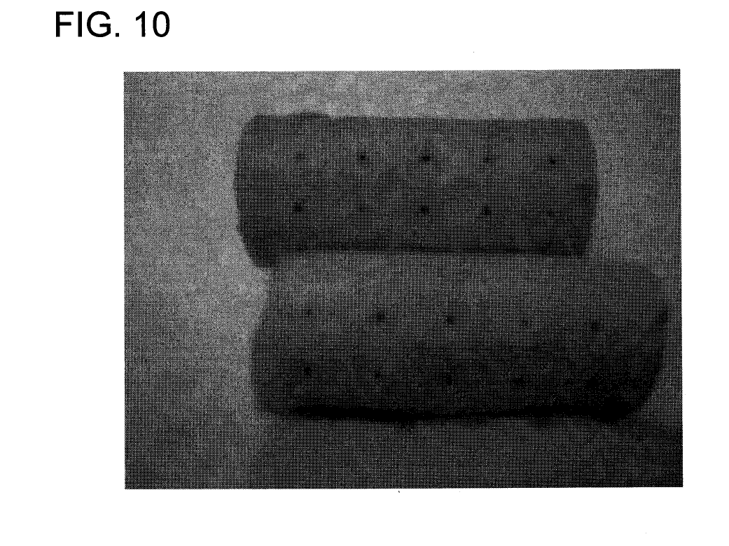

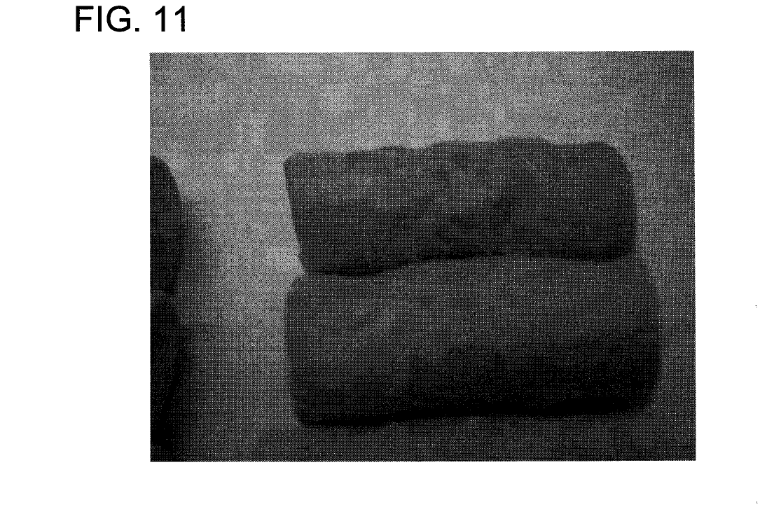

FIGS. 6-8 are photographs of exemplary sausages 600 that were first treated (i.e., pierced with a laser) and then freeze-dried (on the left-hand sides of the photos), as well as exemplary sausages 610 that were freeze-dried without first being so treated (on the right-hand sides of the photos). At least some of the non-treated sausages 610 are malformed and exhibit areas of discoloration, e.g., toward the centers of the sausages. These characteristics are at least partially due to collapse during the freeze-drying process. The treated sausages 600 generally do not exhibit such characteristics. FIGS. 9 and 10 show close-up views of some of the treated, freeze-dried sausages, while FIG. 11 shows close-up views of some of the non-treated, freeze-dried sausages.

In further embodiments, a quantity of liquid nitrogen can be used to pierce one or more items. The liquid nitrogen can be applied using equipment and technology available from, for example, Nitrocision of Idaho Falls, Idaho. The liquid nitrogen can be applied to the one or more items in, for example, one or more streams. The stream can have a pressure of, for example, 6,000 to 55,000 psig. Lowers pressures can also be used (e.g., 5,000 psig, 4,000 psig, 3,000 psig, 2,000 psig, 1,000 psig or less). The liquid nitrogen streams can be applied to the one or more items at one or more angles relative to the one or more items (e.g., approximately 15 degrees, approximately 30 degrees, approximately 45 degrees, approximately 60 degrees, approximately 75 degrees, approximately 90 degrees, or other angles). The stream can pierce a selected depth of the items; in some embodiments, the stream can pierce completely through the items.

In additional embodiments, an ultrasonic cutting device can be used to pierce one or more items. The ultrasonic cutting device can be similar to equipment available from, for example, Dukane Corporation of St. Charles, Ill. The ultrasonic cutting device can be configured to pierce the one or more items to a selected depth including, for example, completely piercing the items.

Having illustrated and described the principles of the disclosed technology, it will be apparent to those skilled in the art that the disclosed embodiments can be modified in arrangement and detail without departing from such principles. In view of the many possible embodiments, it will be recognized that the illustrated embodiments include only examples and should not be taken as a limitation on the scope of the invention. For example, although at least some of the examples described in this application deal with food items, the disclosed technologies can also be used with non-food items. Rather, the invention is defined by the following claims and their equivalents. We therefore claim as the invention all such embodiments and equivalents that come within the scope of these claims.

We claim:

1. A method of processing one or more articles, the method comprising:
creating at least one incision in the one or more articles using at least a laser, a quantity of liquid nitrogen, an ultrasonic cutting device, or a combination thereof; and
freeze-drying the one or more articles.

2. The method of claim 1, further comprising rehydrating the one or more freeze-dried articles.

3. The method of claim 1, further comprising at least partially rehydrating the one or more freeze-dried articles.

4. The method of claim 1, wherein the at least one of the articles comprises a skin or membrane, and wherein the at least one incision penetrates the skin or membrane.

5. The method of claim 1, wherein the one or more articles comprise articles of substantially different sizes.

6. The method of claim 1, wherein the at least one incision is created in the one or more articles while the articles are suspended in a fluid.

7. The method of claim 1, wherein a laser is used to create the at least one incision.

8. The method of claim 7, wherein the one or more articles comprise a food article.

9. The method of claim 8, further comprising receiving the one or more food articles.

10. The method of claim 1, wherein a quantity of liquid nitrogen is used to create the at least one incision.

11. The method of claim 10, wherein the quantity of liquid nitrogen is applied to the one or more articles at an angle less than 90 degrees relative to the one or more articles.

12. The method of claim 1, wherein an ultrasonic cutting device is used to create the at least one incision.

13. An article processed according to the method of claim 1.

14. The article of claim 13, wherein the article has been at least partially rehydrated.

15. The method of claim 1, wherein the article comprises a food article.

16. A freeze-dried article comprising an exterior surface, the exterior surface comprising one or more incisions, wherein the incisions were created at least in part by one or more of a laser beam, a quantity of liquid nitrogen, and an ultrasonic cutting device.

17. The article of claim 16, wherein at least a portion of the article is discolored as a result of the one or more incisions.

18. The article of claim 16, wherein the incisions were created by a laser beam.

19. The article of claim 18, wherein article is a food article.

20. The article of claim 16, wherein the incisions were created by a quantity of liquid nitrogen.

21. The article of claim 16, wherein the incisions were created by an ultrasonic cutting device.

22. The article of claim 16, wherein the article comprises a food article.

23. A system comprising:
a device configured to pierce one or more holes in a product, wherein the device comprises one or more of a laser, a quantity of liquid nitrogen, and an ultrasonic cutting device; and
a freeze-drying unit configured to receive and freeze dry the product having one or more holes.

24. The system of claim 23, further comprising a marking head configured to direct a laser beam emitted by the laser.

25. The system of claim 23, wherein the piercing device comprises a laser.

26. The system of claim 25, wherein the product comprises a food product.

27. The system of claim 26, further comprising a receiving area for the product.

28. The system of claim 23, wherein the piercing device comprises a quantity of liquid nitrogen.

29. The system of claim 23, wherein the piercing device comprises an ultrasonic cutting device.

30. The system of claim 23, wherein the product comprises a food product.

31. The system of claim 23, wherein the device configured to pierce one or more holes in the product is configured to pierce at least one of the holes completely through the product.
